(19) United States
(12) Patent Application Publication
(10) Pub. No.: US 2020/0143002 A1
(43) Pub. Date: May 7, 2020

(54) DATA ACQUISITION POINT DEPLOYMENT METHOD AND SYSTEM

(71) Applicant: Chengdu University of Information Technology, Chengdu (CN)

(72) Inventors: Yan Shen, Chengdu (CN); Jie Zhang, Chengdu (CN); Rong Zhang, Chengdu (CN); Yao Jin, Chengdu (CN); Yingjie Hu, Chengdu (CN)

(21) Appl. No.: 16/561,325

(22) Filed: Sep. 5, 2019

(30) Foreign Application Priority Data
Nov. 6, 2018 (CN) 201811310492.9

(51) Int. Cl. G06F 17/50; G06F 17/16; G06N 3/00

(52) U.S. Cl. CPC G06F 17/50; G06F 2217/16; G06N 3/006; G06F 17/16

(57) ABSTRACT

The present invention discloses a data acquisition point deployment method and system. The method includes constructing a fitness function by combining a grid coverage rate of a to-be-detected water area and a scalar field reconstruction error of an environment field of non-uniformly distributed water quality features, then optimizing a location set of sampling points by a particle swarm optimization algorithm and a gravitational search algorithm, to determine the best solution of the location set of the sampling points and a fitness value corresponding to the best solution, and deploying a sampling point according to the best solution of the location set of the sampling points. The method realizes maximized coverage monitoring of the water area and better reconstructs the water quality distribution features of the entire water area to better reflect the water quality status of the entire water environment monitoring area according to a sampled value.

This application claims priority to Chinese application number 201811310492.9, filed Nov. 6, 2018, with a title of DATA ACQUISITION POINT DEPLOYMENT METHOD AND SYSTEM. The above-mentioned patent application is incorporated herein by reference in its entirety.

### TECHNICAL FIELD

The present invention relates to the field of water quality monitoring, and in particular, to a data acquisition point deployment method and system.

### BACKGROUND

When sampling points of a water environment field are deployed, they are deployed uniformly often in a manner that considers a monitoring coverage rate, that is, a cost function based on the coverage rate is constructed, and an iterative search is performed by using a particle swarm optimization algorithm to obtain the best sampling point deployment structure. However, the method of merely considering the coverage rate to uniformly deploy the sampling points is only applicable to a situation where water environment features are distributed uniformly, and as the particle swarm algorithm has the shortcomings of being slow in convergence speed, easy to fall into local best and the like, in case water environment features are in Gaussian distribution, data information obtained by this method is not sufficient to reflect the water quality status of an entire area.

### SUMMARY

An objective of the present invention is to provide a data sampling point deployment method and system, to better reflect the water quality status of an entire water environment monitoring area according to a sampled value.

To achieve the above purpose, the present invention provides the following technical solutions.

A data acquisition point deployment method includes:
determining a grid coverage rate of a to-be-detected water area and a scalar field reconstruction error of an environment field of non-uniformly distributed water quality features;
constructing a fitness function by combining the grid coverage rate and the scalar field reconstruction error;
optimizing a location set of sampling points by a particle swarm optimization algorithm and a gravitational search algorithm according to the fitness function, to determine the best solution of the location set of the sampling points and a fitness value corresponding to the best solution; and
deploying a data sampling point in the to-be-detected water area according to the location of a sampling point corresponding to the best solution of the location set of the sampling points.

Optionally, the determining a grid coverage rate of a to-be-detected water area specifically includes:
discretizing S zones in a two-dimensional plane of the to-be-monitored water area into grids of equal unit side length, the number of the grids being C;
randomly deploying D sampling points on the grids, the location of each of the sampling points being X_{d}=(x_{d}, y_{d}), d=1, 2, L, D;
using a Boolean sensing model to determine whether a grid in which a sampling point is located is covered, to obtain a determination result, the Boolean sensing model being:

$$P ( {X}_{d} , p ) = \{ \begin{matrix}1 & Dis ( {X}_{d} , p ) \leq {R}_{S} \\ 0 & Dis ( {X}_{d} , p ) > {R}_{S}\end{matrix} ,$$

where when Dis(X_{d}, p)≤R_{S}, P(X_{d},p)=1, indicating that the grid where the sampling point is located is covered; when Dis(X_{d}, p)>R_{S}, P(X_{d}, p)=0, indicating that the grid where the sampling point is located is not covered; Dis(X_{d}, p) is an Euclidean distance from the sampling point d to a central point p(x, y) of any of the grids: Dis(X_{d}, P)={square root over ((x_{d}−x)²(y_{d}−y²)}; R_{S} is an effective sensing radius of a monitoring point;
determining the number C_{S} of covered grids according to the determination result; and
calculating the grid coverage rate according to the formula

$${f}_{1} = \frac{{C}_{S}}{C} .$$

Optionally, the determining a scalar field reconstruction error of an environment field of non-uniformly distributed water quality features specifically includes:
determining the number I of error analysis location points (x, y);
obtaining a true temperature value Z of any of the location points in the environment field of non-uniformly distributed water quality features and an estimated value Z corresponding to the true temperature value Z of the location point; and
calculating the scalar field reconstruction error by the formula

$${f}_{2} = \frac{1}{I} {\sum }_{i = 1}^{I} {( Z - {Z}^{′} )}^{2} .$$

Optionally, the constructing a fitness function specifically includes:
constructing a fitness function with a purpose of maximizing the grid coverage rate and minimizing the scalar field reconstruction error, the fitness function being: fitness=a* (1−ƒ₁)+b*ƒ₂,
where a and b are constant factors; ƒ₁ is the grid coverage rate; ƒ₂ is the scalar field reconstruction error.

Optionally, the optimizing a location set of sampling points by a particle swarm optimization algorithm and a gravitational search algorithm, to determine the best solution of the location set of the sampling points and a fitness value corresponding to the best solution specifically includes:
(1) initializing the location and velocity of each particle in a particle swarm, where the location satisfies the formula

$$X = ( \begin{matrix}{{X}^{V}}_{1} \\ {{X}^{V}}_{2} \\ M \\ {{X}^{V}}_{N}\end{matrix} ) = ( \begin{matrix}{X}_{11} & {X}_{12} & {X}_{13} & {X}_{1 D} \\ {X}_{21} & {X}_{22} & {X}_{23} & {X}_{2 D} \\ M & M & O & M \\ {X}_{N 1} & {X}_{N 2} & {X}_{N 3} & {X}_{ND}\end{matrix} ) ,$$

and the velocity satisfies the formula

$$V = ( \begin{matrix}{{V}^{V}}_{1} \\ {{V}^{V}}_{2} \\ M \\ {{V}^{V}}_{N}\end{matrix} ) = ( \begin{matrix}{V}_{11} & {V}_{12} & {V}_{13} & {V}_{1 D} \\ {V}_{21} & {V}_{22} & {V}_{23} & {V}_{2 D} \\ M & M & O & M \\ {V}_{N 1} & {V}_{N 2} & {V}_{N 3} & {V}_{ND}\end{matrix} ) ;$$

the particle represents a location set of a group of sampling points, i.e. [symbol] =(Xᵢ₁, Xᵢ₂, . . . , X_{iD}), where and X_{id}=(x_{id}, y_{id}), i=1, 2, . . . , N and d=1, 2, . . . , D; X_{id} indicates the location of a sampling point d; \vec{X}ᵢ indicates the location of a particle i; V_{id} indicates the velocity of the sampling point d; \vec{V}ᵢ indicates the velocity of the particle i;
(2) determining a maximum iteration number Gₘₐₓ;
(3) calculating a fitness value fitness_{\vec{X}}_{ᵢ} of the particle according to the fitness function;
(4) comparing the fitness values of all particles in the particle swarm, determining a minimum value of the fitness values, using a particle corresponding to the minimum value of the fitness values as the best solution of the location set of the sampling points, and using the minimum value of the fitness values as a fitness value fitness [symbol] corresponding to the best solution; and
(5) determining whether an iteration number reaches the maximum iteration number; if yes, outputting the best solution of the location set of the sampling points and the fitness value fitness [symbol] corresponding to the best solution; if not, updating the velocity and location of each of the particles by the formulas [symbol] ^{T}=w× [symbol] ^{T}+ [symbol] ^{T}+c×randᵢ×( [symbol] ^{T}− [symbol] ^{T}) and [symbol] ^{T}= [symbol] ^{T}+ [symbol] ^{T}, and returning to the step (3),
where \vec{V}ᵢ^{T} indicates transposition of a velocity matrix of the particle i; \vec{V}ᵢ₊₁^{T} indicates transposition of a velocity matrix of the particle i after updating; [symbol] ᵢ^{T} indicates transposition of a location matrix of the particle i; \vec{X}ᵢ₊₁^{T} indicates transposition of a location matrix of the particle i after updating; c indicates a learning factor; randᵢ indicates a uniform random number of [0,1]; Lbest is a global best solution in the optimization process; w is an inertia weight;
a calculation formula of the inertia weight is:

$$w = \{ \begin{matrix}{w}_{min} - \frac{( {w}_{max} - {w}_{min} ) \times ( f - {f}_{min} )}{( {f}_{avg} - {f}_{min} )} , f \leq {f}_{avg} \\ {w}_{max} , f > {f}_{avg}\end{matrix} ,$$

where wₘₐₓ is a maximum value of the inertia weight; wₘᵢₙ is a minimum value of the inertia weight; ƒ indicates a fitness function value of the particle; ƒ_{avg} indicates an average fitness function value of all particles; ƒₘᵢₙ indicates a minimum fitness function value of all particles.

A data acquisition point deployment system includes:
a grid coverage rate and scalar field reconstruction error determining unit, for determining a grid coverage rate of a to-be-detected water area and a scalar field reconstruction error of an environment field of non-uniformly distributed water quality features;
a fitness function construction unit, for constructing a fitness function by combining the grid coverage rate and the scalar field reconstruction error;
an optimizing unit, for optimizing a location set of sampling points by a particle swarm optimization algorithm and a gravitational search algorithm according to the fitness function, to determine the best solution of the location set of the sampling points and a fitness value corresponding to the best solution; and
a deployment unit, for deploying a data sampling point in the to-be-detected water area according to the location of a sampling point corresponding to the best solution of the location set of the sampling points.

Optionally, the grid coverage rate and scalar field reconstruction error determining unit includes a grid coverage rate determining subunit; the grid coverage rate determining subunit is configured for determining the grid coverage rate of the to-be-detected water area, and specifically includes:
a grid partition module, for discretizing S zones in a two-dimensional plane of the to-be-monitored water area into grids of equal unit side length, the number of the grids being C;
a random deployment module, for randomly deploying D sampling points on the grids, the location of each of the sampling points being X_{d}=(x_{d}, y_{d}), d=1, 2, L, D;
a Boolean sensing model determining module, for using a Boolean sensing model to determine whether a grid in which a sampling point is located is covered, to obtain a determination result, the Boolean sensing model being:

$$P ( {X}_{d} , p ) = \{ \begin{matrix}1 & Dis ( {X}_{d} , p ) \leq {R}_{S} \\ 0 & Dis ( {X}_{d} , p ) > {R}_{S}\end{matrix} ,$$

where when Dis(X_{d}, p)≤R_{S}, P(X_{d}, p)=1, indicating that (the grid where the sampling point is located is covered; when Dis(X_{d}, p)>R_{S}, P(X_{d}, p)=0, indicating that the grid where the sampling point is located is not covered; Dis(X_{d}, p)is an Euclidean distance from the sampling point d to a central point p=(x, y) of any of the grids: Dis(X_{d}, p)=\sqrt{(x_{d}−x)²+(y_{d}−y)²}; R_{S} is an effective sensing radius of a monitoring point;
a covered grid number determining module, for determining the number C_{S} of covered grids according to the determination result; and
a grid coverage rate calculation module, for calculating the grid coverage rate according to the formula

$${f}_{1} = \frac{{C}_{S}}{C} .$$

Optionally, the grid coverage rate and scalar field reconstruction error determining unit further includes a scalar field reconstruction error determining subunit; the scalar field reconstruction error determining subunit is configured for determining the scalar field reconstruction error of the environment field of non-uniformly distributed water quality features, and specifically includes:
an error analysis point determining module, for determining the number I of error analysis location points (x, y);
a temperature obtaining module, for obtaining a true temperature value Z of any of the location points in the environment field of non-uniformly distributed water quality features and an estimated value Z corresponding to the true temperature value Z of the location point; and
a scalar field reconstruction error calculation module, for calculating the scalar field reconstruction error by the formula

$${f}_{2} = \frac{1}{I} {\sum }_{i = 1}^{I} {( Z - {Z}^{′} )}^{2} .$$

Optionally, the fitness function construction unit is configured for constructing a fitness function, and specifically includes:
a fitness function construction subunit, for constructing a fitness function with a purpose of maximizing the grid coverage rate and minimizing the scalar field reconstruction error, the fitness function being: fitness=a*(1−ƒ₁)+b*ƒ₂;
where a and b are constant factors; ƒ₁ is the grid coverage rate; ƒ₂ is the scalar field reconstruction error.

Optionally, the optimizing unit is configured for optimizing a location set of sampling points by a particle swarm optimization algorithm and a gravitational search algorithm, to determine the best solution of the location set of the sampling points and a fitness value corresponding to the best solution, and specifically includes:
a particle initializing subunit, for initializing the location and velocity of each particle in a particle swarm, where the location satisfies the formula

$$X = ( \begin{matrix}{\vec{X}}_{1} \\ {\vec{X}}_{2} \\ ⋮ \\ {\vec{X}}_{N}\end{matrix} ) = ( \begin{matrix}{X}_{11} & {X}_{12} & {X}_{13} & {X}_{1 D} \\ {X}_{21} & {X}_{22} & {X}_{23} & {X}_{2 D} \\ ⋮ & ⋮ & ⋱ & ⋮ \\ {X}_{N 1} & {X}_{N 2} & {X}_{N 3} & {X}_{ND}\end{matrix} ) ,$$

and the velocity satisfies the formula

$$V = ( \begin{matrix}{\vec{V}}_{1} \\ {\vec{V}}_{2} \\ ⋮ \\ {\vec{V}}_{N}\end{matrix} ) = ( \begin{matrix}{V}_{11} & {V}_{12} & {V}_{13} & {V}_{1 D} \\ {V}_{21} & {V}_{22} & {V}_{23} & {V}_{2 D} \\ ⋮ & ⋮ & ⋱ & ⋮ \\ {V}_{N 1} & {V}_{N 2} & {V}_{N 3} & {V}_{ND}\end{matrix} ) ;$$

the particle represents a location set of a group of sampling points, i.e. [symbol] =(Xᵢ₁, Xᵢ₂, . . . , X_{iD}), where X_{id}=(x_{id}, y_{id}), i=1, 2, . . . , N and d=1, 2, . . . , D; X_{id} indicates the location of a sampling point d; \vec{X}ᵢ indicates the location of a particle i; V_{id} indicates the velocity of the sampling point d; \vec{V}ᵢ indicates the velocity of the particle i;
a maximum iteration number determining subunit, for determining a maximum iteration number Gₘₐₓ;
a fitness function calculation subunit, for calculating a fitness value fitness_{\vec{X}}_{ᵢ} of the particle according to the fitness function;

a fitness value comparison subunit, for comparing the fitness values of all particles in the particle swarm, determining a minimum value of the fitness values, using a particle corresponding to the minimum value of the fitness values as the best solution of the location set of the sampling points, and using the minimum value of the fitness values as a fitness value fitness [symbol] corresponding to the best solution; and
an iteration number determination subunit, for determining whether an iteration number reaches the maximum iteration number; if yes, outputting the best solution of the location set of the sampling points and the fitness value fitness [symbol] corresponding to the best solution; if not, updating the velocity and location of each of the particles by the formulas [symbol] ^{T}=w× [symbol] ^{T}+ [symbol] ^{T}+c×randᵢ×( [symbol] ^{T}− [symbol] ^{T}) and [symbol] ^{T}= [symbol] ^{T}+ [symbol] ^{T}, and returning to the step (3),
where \vec{V}ᵢ^{T} indicates transposition of a velocity matrix of the particle i; [symbol] indicates transposition of a velocity matrix of the particle i after updating; [symbol] ᵢ^{T} indicates transposition of a location matrix of the particle i; \vec{X}ᵢ₊₁^{T} indicates transposition of a location matrix of the particle i after updating; c indicates a learning factor; randᵢ indicates a uniform random number of [0,1]; Lbest is a global best solution in the optimization process; w is an inertia weight;
a calculation formula of the inertia weight is:

$$w = \{ \begin{matrix}{w}_{min} - \frac{( {w}_{max} - {w}_{min} ) \times ( f - {f}_{min} )}{( {f}_{avg} - {f}_{min} )} , f \leq {f}_{avg} \\ {w}_{max} , f > {f}_{avg}\end{matrix} ,$$

where wₘₐₓ is a maximum value of the inertia weight; wₘᵢₙ is a minimum value of the inertia weight; ƒ indicates a fitness function value of the particle; ƒ_{avg} indicates an average fitness function value of all particles; ƒₘᵢₙ indicates a minimum fitness function value of all particles.

According to specific embodiments provided in the present invention, the present invention discloses the following technical effects. The present invention considers both coverage performance and reconstruction performance that can reflect the quality of sampled data to construct a fitness function, making sampling points maximally cover an environmental scalar field; to search for the best sampling point, a traditional particle swarm optimization algorithm is combined with a gravitational search algorithm to optimize a location set of the sampling points to determine the best solution of the location set of the sampling points and a fitness value corresponding to the best solution, thereby improving the convergence speed and accuracy of the algorithm to well reflect the water quality status of an entire water environment monitoring area according to a sampled value.

### BRIEF DESCRIPTION OF THE DRAWINGS

To describe the technical solutions in the embodiments of the present invention or in the prior art more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a data acquisition point deployment method provided in Embodiment 1 of the present invention; and

FIG. 2 is a structural block diagram of a data acquisition point deployment system provided in Embodiment 2 of the present invention.

### DETAILED DESCRIPTION

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

An objective of the present invention is to provide a data acquisition point deployment method and system, to better reflect the water quality status of an entire water environment monitoring area according to a sampled value.

To make the foregoing objective, features, and advantages of the present invention clearer and more comprehensible, the present invention is further described in detail below with reference to the accompanying drawings and specific embodiments.

### Embodiment 1

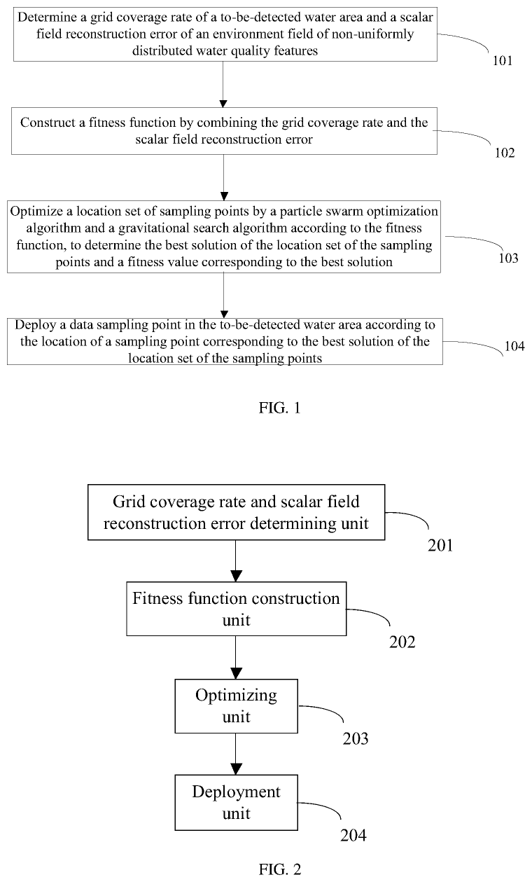

As shown in FIG. 1, a data acquisition point deployment method provided in the present embodiment includes the following steps.

Step 101: determine a grid coverage rate of a to-be-detected water area and a scalar field reconstruction error of an environment field of non-uniformly distributed water quality features.

In the present embodiment, specifically, the following steps are performed to determine the grid coverage rate of the to-be-detected water area and the scalar field reconstruction error of the environment field of non-uniformly distributed water quality features.

The step of determining a grid coverage rate of a to-be-detected water area specifically includes:
discretize S zones in a two-dimensional plane of the to-be-monitored water area into grids of equal unit side length, the number of the grids being C;
randomly deploy D sampling points on the grids, the location of each of the sampling points being X_{d}=(x_{d}, y_{d}), d=1, 2, L, D;
use a Boolean sensing model to determine whether a grid in which a sampling point is located is covered, to obtain a determination result, the Boolean sensing model being:

$$P ( {X}_{d} , p ) = \{ \begin{matrix}1 & Dis ( {X}_{d} , p ) \leq {R}_{S} \\ 0 & Dis ( {X}_{d} , p ) > {R}_{S}\end{matrix} ,$$

where when Dis(X_{d}, p)≤R_{S}, P(X_{d}, p)=1 indicating that the grid where the sampling point is located is covered; when Dis(X_{d}, p)>R_{S}, P(X_{d}, p)=0, indicating that the grid where the sampling point is located is not covered; Dis(X_{d}, p) is an Euclidean distance from the sampling point d to a central point p(x, y) of any of the grids: Dis(X_{d}, p)=\sqrt{(x_{d}−x)²+(y_{d}−y)²}; R_{S} is an effective sensing radius of a monitoring point;
determine the number Cₛ of covered grids according to the determination result; and
calculate the grid coverage rate according to the formula

$${f}_{1} = \frac{{C}_{S}}{C} .$$

The grid coverage rate determined by the Boolean sensing model can reflect actual coverage more accurately, and can be directly used as a measurement index for a water environment detection coverage rate.

The step of determining a scalar field reconstruction error of an environment field of non-uniformly distributed water quality features specifically includes:
determine the number I of error analysis location points (x, y);
obtain a true temperature value Z of any of the location points in the environment field of non-uniformly distributed water quality features and an estimated value Z corresponding to the true temperature value Z of the location point; and
calculate the scalar field reconstruction error by the formula

$${f}_{2} = \frac{1}{I} {\sum }_{i = 1}^{I} {( Z - {Z}^{′} )}^{2} .$$

For the environment field of non-uniformly distributed water quality features, more sampling locations are deployed in a zone with a larger change and an obvious feature, while a relatively few sampling points are deployed in a gently changing zone, thus obtaining better environmental scalar field reconstruction performance compared to a method of completely uniform deployment.

Step 102: construct a fitness function by combining the grid coverage rate and the scalar field reconstruction error.

The step of constructing a fitness function specifically includes:
construct a fitness function with a purpose of maximizing the grid coverage rate and minimizing the scalar field reconstruction error, the fitness function being: fitness=a*(1−ƒ₁)+b*ƒ₂;
where a and b are constant factors; ƒ₁ is the grid coverage rate; ƒ₂ is the scalar field reconstruction error; 1−ƒ₁ converts a maximum coverage rate into a minimum coverage hole, turning an optimization purpose into a problem of solving a minimum value of the function.

A performance measurement criterion of water environment detection based on a maximum coverage rate and a minimum scalar field reconstruction error is established by the fitness function, so that the sampling point deployment can achieve maximum coverage of an environmental scalar field.

Step 103: optimize a location set of sampling points by a particle swarm optimization algorithm and a gravitational search algorithm according to the fitness function, to determine the best solution of the location set of the sampling points and a fitness value corresponding to the best solution.

The step of optimizing a location set of sampling points by a particle swarm optimization algorithm and a gravitational search algorithm, to determine the best solution of the location set of the sampling points and a fitness value corresponding to the best solution specifically includes:
(1) initialize the location and velocity of each particle in a particle swarm, where the location satisfies the formula

$$X = ( \begin{matrix}{\vec{X}}_{1} \\ {\vec{X}}_{2} \\ ⋮ \\ {\vec{X}}_{N}\end{matrix} ) = ( \begin{matrix}{X}_{11} & {X}_{12} & {X}_{13} & {X}_{1 D} \\ {X}_{21} & {X}_{22} & {X}_{23} & {X}_{2 D} \\ ⋮ & ⋮ & ⋱ & ⋮ \\ {X}_{N 1} & {X}_{N 2} & {X}_{N 3} & {X}_{ND}\end{matrix} ) ,$$

and the velocity satisfies the formula

$$V = ( \begin{matrix}{\vec{V}}_{1} \\ {\vec{V}}_{2} \\ ⋮ \\ {\vec{V}}_{N}\end{matrix} ) = ( \begin{matrix}{V}_{11} & {V}_{12} & {V}_{13} & {V}_{1 D} \\ {V}_{21} & {V}_{22} & {V}_{23} & {V}_{2 D} \\ ⋮ & ⋮ & ⋱ & ⋮ \\ {V}_{N 1} & {V}_{N 2} & {V}_{N 3} & {V}_{ND}\end{matrix} ) ;$$

the particle represents a location set of a group of sampling points, i.e. [symbol] =(Xᵢ₁, Xᵢ₂, . . . , X_{iD}), where X_{id}=(x_{id}, y_{id}), i=1, 2, . . . , N and d=1, 2, . . . , D; X_{id} indicates the location of a sampling point d; \vec{X}ᵢ indicates the location of a particle i; V_{id} indicates the velocity of the sampling point d; \vec{V}ᵢ indicates the velocity of the particle i;
(2) determine a maximum iteration number Gₘₐₓ;
(3) calculate a fitness value fitness_{\vec{X}}_{ᵢ} of the particle according to the fitness function;
(4) compare the fitness values of all particles in the particle swarm, determine a minimum value of the fitness values, use a particle corresponding to the minimum value of the fitness values as the best solution of the location set of the sampling points, and use the minimum value of the fitness values as a fitness value fitness [symbol] corresponding to the best solution; and
(5) determine whether an iteration number reaches the maximum iteration number; if yes, output the best solution of the location set of the sampling points and the fitness value fitness [symbol] corresponding to the best solution; if not, update the velocity and location of each of the particles by the formulas [symbol] ^{T}=w× [symbol] ^{T}+ [symbol] ^{T}+c×randᵢ×( [symbol] ^{T}− [symbol] ^{T}) and [symbol] ^{T}= [symbol] ^{T}+ [symbol] ^{T}, and return to the step (3),
where \vec{V}ᵢ^{T} indicates transposition of a velocity matrix of the particle i; \vec{V}ᵢ₊₁^{T} indicates transposition of a velocity matrix of the particle i after updating; [symbol] ᵢ^{T} indicates transposition of a location matrix of the particle i; \vec{X}ᵢ₊₁^{T} indicates transposition of a location matrix of the particle i after updating; c indicates a learning factor; randᵢ indicates uniform random number of [0,1]; Lbest is a global best solution in the optimization process; w is an inertia weight;
the inertia weight can reflect the capability of a particle to inherit a current velocity; to balance a global search capability and a local improvement capability of the algorithm, the inertia weight adopts an adaptive weight, and a calculation formula is:

$$w = \{ \begin{matrix}{w}_{min} - \frac{( {w}_{max} - {w}_{min} ) \times ( f - {f}_{min} )}{( {f}_{avg} - {f}_{min} )} , f \leq {f}_{avg} \\ {w}_{max} , f > {f}_{avg}\end{matrix} ,$$

where wₘₐₓ is a maximum value of the inertia weight; wₘᵢₙ is a minimum value of the inertia weight; ƒ indicates a fitness function value of the particle; ƒ_{avg} indicates an average fitness function value of all particles; ƒₘᵢₙ indicates a minimum fitness function value of all particles.

The location set of the sampling points is optimized by the particle swarm optimization algorithm and the gravitational search algorithm, to determine the best solution of the location set of the sampling points and a fitness value corresponding to the best solution, thereby realizing maximized coverage monitoring of the water area and better reconstructing the water quality distribution features of the entire water area to better reflect the water quality status of the entire water environment monitoring area.

Step 104: deploy a data sampling point in the to-be-detected water area according to the location of a sampling point corresponding to the best solution of the location set of the sampling points.

The data acquisition point deployment method proposed by the present application combines the grid coverage rate and the scalar field reconstruction error as a performance measurement standard for a water environment test, establishes a fitness function correlated to the measurement standard, and by optimizing, determines the best solution of the location set of the sampling points and a fitness value corresponding to the best solution, thereby realizing maximized coverage monitoring of the water area and better reconstructing the water quality distribution features of the entire water area to better reflect the water quality status of the entire water environment monitoring area.

### Embodiment 2

As shown in FIG. 2, a data acquisition point deployment system provided in the present embodiment includes: a grid coverage rate and scalar field reconstruction error determining unit 201, a fitness function construction unit 202, an optimizing unit 203, and a deployment unit 204.

The grid coverage rate and scalar field reconstruction error determining unit 201 is configured for determining a grid coverage rate of a to-be-detected water area and a scalar field reconstruction error of an environment field of non-uniformly distributed water quality features.

The grid coverage rate and scalar field reconstruction error determining unit 201 includes a grid coverage rate determining subunit and a scalar field reconstruction error determining subunit.

The grid coverage rate determining subunit specifically includes:
a grid partition module, for discretizing S zones in a two-dimensional plane of the to-be-monitored water area into grids of equal unit side length, the number of the grids being C;
a random deployment module, for randomly deploying D sampling points on the grids, the location of each of the sampling points being X_{d}=(x_{d}, y_{d}), d=1, 2, L, D;
a Boolean sensing model determining module, for using a Boolean sensing model to determine whether a grid in which a sampling point is located is covered, to obtain a determination result, the Boolean sensing model being:

$$P ( {X}_{d} , p ) = \{ \begin{matrix}1 & Dis ( {X}_{d} , p ) \leq {R}_{S} \\ 0 & Dis ( {X}_{d} , p ) > {R}_{S}\end{matrix} ,$$

where when Dis(X_{d}, p)≤R_{S}, P (X_{d}, p)=1, indicating that the grid where the sampling point is located is covered; when Dis(X_{d}, p)>R_{S}, P(X_{d}, p)=0, indicating that the grid where the sampling point is located is not covered; Dis(X_{d}, p) is an Euclidean distance from the sampling point d to a central point p=(x, y) of any of the grids: Dis(X_{d}, p)=\sqrt{(x_{d}−x)²+(y_{d}−y)²}; R_{S} is an effective sensing radius of a monitoring point;
a covered grid number determining module, for determining the number C_{S} of covered grids according to the determination result; and
a grid coverage rate calculation module, for calculating the grid coverage rate according to the formula

$${f}_{1} = \frac{{C}_{S}}{C} .$$

The grid coverage rate determined by the Boolean perception model can reflect actual coverage more accurately, and can be directly used as a measurement index for a water environment detection coverage rate.

The scalar field reconstruction error determining subunit specifically includes:
an error analysis point determining module, for determining the number I of error analysis location points (x, y);
a temperature obtaining module, for obtaining a true temperature value Z of any of the location points in the environment field of non-uniformly distributed water quality features and an estimated value Z corresponding to the true temperature value Z of the location point; and
a scalar field reconstruction error calculation module, for calculating the scalar field reconstruction error by the formula

$${f}_{2} = \frac{1}{I} {\sum }_{i = 1}^{I} {( Z - {Z}^{′} )}^{2} .$$

For the environment field of non-uniformly distributed water quality features, more sampling locations are deployed in a zone with a larger change and an obvious feature, while a relatively few sampling points are deployed in a gently changing zone, thus obtaining better environmental scalar field reconstruction performance compared to a method of completely uniform deployment.

The fitness function construction unit 202 is configured for constructing a fitness function by combining the grid coverage rate and the scalar field reconstruction error. The fitness function construction unit 202 specifically includes:
a fitness function construction subunit, for constructing a fitness function with a purpose of maximizing the grid coverage rate and minimizing the scalar field reconstruction error, the fitness function being: fitness=a*(1−ƒ₁)+b*ƒ₂;
where a and b are constant factors; ƒ₁ is the grid coverage rate; ƒ₂ is the scalar field reconstruction error; 1−ƒ₁ converts a maximum coverage rate into a minimum coverage hole, turning an optimization purpose into a problem of solving a minimum value of the function.

A performance measurement criterion for water environment detection based on a maximum coverage rate and a minimum scalar field reconstruction error is established by the fitness function, so that the sampling point deployment can achieve maximum coverage of an environmental scalar field.

The optimizing unit 203 is configured for optimizing a location set of sampling points by a particle swarm optimization algorithm and a gravitational search algorithm according to the fitness function, to determine the best solution of the location set of the sampling points and a fitness value corresponding to the best solution. The optimizing unit 203 specifically includes:
a particle initializing subunit, for initializing the location and velocity of each particle in a particle swarm, where the location satisfies the formula

$$X = ( \begin{matrix}{\vec{X}}_{1} \\ {\vec{X}}_{2} \\ ⋮ \\ {\vec{X}}_{N}\end{matrix} ) = ( \begin{matrix}{X}_{11} & {X}_{12} & {X}_{13} & {X}_{1 D} \\ {X}_{21} & {X}_{22} & {X}_{23} & {X}_{2 D} \\ ⋮ & ⋮ & ⋱ & ⋮ \\ {X}_{N 1} & {X}_{N 2} & {X}_{N 3} & {X}_{ND}\end{matrix} ) ,$$

and
the velocity satisfies the formula

$$V = ( \begin{matrix}{\vec{V}}_{1} \\ {\vec{V}}_{2} \\ ⋮ \\ {\vec{V}}_{N}\end{matrix} ) = ( \begin{matrix}{V}_{11} & {V}_{12} & {V}_{13} & {V}_{1 D} \\ {V}_{21} & {V}_{22} & {V}_{23} & {V}_{2 D} \\ ⋮ & ⋮ & ⋱ & ⋮ \\ {V}_{N 1} & {V}_{N 2} & {V}_{N 3} & {V}_{ND}\end{matrix} ) ;$$

the particle represents a location set of a group of sampling points, i.e. [symbol] =(Xᵢ₁, Xᵢ₂, . . . , X_{iD}), where X_{id}=(x_{id}, y_{id}), i=1, 2, . . . , N and d=1, 2, . . . , D; X_{id} indicates the location of a sampling point d; \vec{X}ᵢ indicates the location of a particle i; V_{id} indicates the velocity of the sampling point d; \vec{V}ᵢ indicates the velocity of the particle i;
a maximum iteration number determining subunit, for determining a maximum iteration number Gₘₐₓ;
a fitness function calculation subunit, for calculating a fitness value fitness_{\vec{X}}_{ᵢ} of the particle according to the fitness function;
a fitness value comparison subunit, for comparing the fitness values of all particles in the particle swarm, determining a minimum value of the fitness values, using a particle corresponding to the minimum value of the fitness values as the best solution of the location set of the sampling points, and using the minimum value of the fitness values as a fitness value fitness [symbol] corresponding to the best solution; and
an iteration number determination subunit, for determining whether an iteration number reaches the maximum iteration number; if yes, outputting the best solution of the location set of the sampling points and the fitness value fitness [symbol] corresponding to the best solution; if not, updating the velocity and location of each of the particles by the formulas [symbol] ^{T}=w× [symbol] ^{T}+ [symbol] ^{T}+c×randᵢ×( [symbol] ^{T}− [symbol] ^{T}) and [symbol] ^{T}= [symbol] ^{T}+ [symbol] ^{T}, and returning to the and returning to the fitness function calculation subunit,
where \vec{V}ᵢ^{T} indicates transposition of a velocity matrix of the particle i; \vec{V}ᵢ₊₁^{T} indicates transposition of a velocity matrix of the particle i after updating; [symbol] ᵢ^{T} indicates transposition of a location matrix of the particle i; \vec{X}ᵢ₊₁^{T} indicates transposition of a location matrix of the particle i after updating; c indicates a learning factor; randᵢ indicates a uniform random number of [0,1]; Lbest is a global best solution in the optimization process; w is an inertia weight;
the inertia weight can reflect the capability of a particle to inherit a current velocity; to balance a global search capability and a local improvement capability of the algorithm, the inertia weight adopts an adaptive weight, and a calculation formula is:

$$w = \{ \begin{matrix}{w}_{min} - \frac{( {w}_{max} - {w}_{min} ) \times ( f - {f}_{min} )}{( {f}_{avg} - {f}_{min} )} , f \leq {f}_{avg} \\ {w}_{max} , f > {f}_{avg}\end{matrix} ,$$

where wₘₐₓ is a maximum value of the inertia weight; wₘᵢₙ is a minimum value of the inertia weight; ƒ indicates a fitness function value of the particle; ƒ_{avg} indicates an average fitness function value of all particles; ƒₘᵢₙ indicates a minimum fitness function value of all particles.

The location set of the sampling points is optimized by the particle swarm optimization algorithm and the gravitational search algorithm, to determine the best solution of the location set of the sampling points and a fitness value corresponding to the best solution, thereby realizing maximized coverage monitoring of the water area and better reconstructing the water quality distribution features of the entire water area to better reflect the water quality status of the entire water environment monitoring area.

The deployment unit 204 is configured for deploying a data sampling point in the to-be-detected water area according to the location of a sampling point corresponding to the best solution of the location set of the sampling points.

The data acquisition point deployment system proposed by the present application combines the grid coverage rate determining subunit and the scalar field reconstruction error determining subunit to form a performance measurement standard for a water environment test, establishes a fitness function correlated to the measurement standard, and by the optimizing unit, determines the best solution of the location set of the sampling points and a fitness value corresponding to the best solution, thereby realizing maximized coverage monitoring of the water area and better reconstructing the water quality distribution features of the entire water area to better reflect the water quality status of the entire water environment monitoring area.

For a system disclosed in the embodiments, since it corresponds to the method disclosed in the embodiments, the description is relatively simple, and reference can be made to the method description.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the content of this specification shall not be construed as a limitation to the present invention.

What is claimed is:

1. A data acquisition point deployment method, wherein the method comprises:
determining a grid coverage rate of a to-be-detected water area and a scalar field reconstruction error of an environment field of non-uniformly distributed water quality features;
constructing a fitness function by combining the grid coverage rate and the scalar field reconstruction error;
optimizing a location set of sampling points by a particle swarm optimization algorithm and a gravitational search algorithm according to the fitness function, to determine the best solution of the location set of the sampling points and a fitness value corresponding to the best solution; and
deploying a data sampling point in the to-be-detected water area according to the location of a sampling point corresponding to the best solution of the location set of the sampling points.

2. The data acquisition point deployment method according to claim 1, wherein the determining a grid coverage rate of a to-be-detected water area specifically comprises:
discretizing S zones in a two-dimensional plane of the to-be-monitored water area into grids of equal unit side length, the number of the grids being C;
randomly deploying D sampling points on the grids, the location of each of the sampling points being X_{d}=(x_{d}, y_{d}), d=1, 2, L, D;
using a Boolean sensing model to determine whether a grid in which a sampling point is located is covered, to obtain a determination result, the Boolean sensing model being:
$$P ( {X}_{d} , p ) = \{ \begin{matrix}1 & Dis ( {X}_{d} , p ) \leq {R}_{S} \\ 0 & Dis ( {X}_{d} , p ) > {R}_{S}\end{matrix} ,$$
wherein when Dis(X_{d}, p)≤R_{S}, P(X_{d}, p)=1, indicating that the grid where the sampling point is located is covered; when Dis(X_{d}, p)>R_{S}, P(X_{d}, p)=0, indicating that the grid where the sampling point is located is not covered; Dis(X_{d}, p) is an Euclidean distance from the sampling point d to a central point p(x, y) of any of the grids: Dis(X_{d}, p)=\sqrt{(x_{d}−x)²+(y_{d}−y)²}; R_{S} is an effective sensing radius of a monitoring point;
determining the number C_{S} of covered grids according to the determination result; and
calculating the grid coverage rate according to the formula
$${f}_{1} = \frac{{C}_{S}}{C} .$$

3. The data acquisition point deployment method according to claim 1, wherein the determining a scalar field reconstruction error of an environment field of non-uniformly distributed water quality features specifically comprises:
determining the number I of error analysis location points (x, y);
obtaining a true temperature value Z of any of the location points in the environment field of non-uniformly distributed water quality features and an estimated value Z corresponding to the true temperature value Z of the location point; and
calculating the scalar field reconstruction error by the formula
$${f}_{2} = \frac{1}{I} {\sum }_{i = 1}^{I} {( Z - {Z}^{′} )}^{2} .$$

4. The data acquisition point deployment method according to claim 1, wherein the constructing a fitness function specifically comprises:
constructing a fitness function with a purpose of maximizing the grid coverage rate and minimizing the scalar field reconstruction error, the fitness function being: fitness=a*(1−ƒ₁)+b*ƒ₂;
wherein a and b are constant factors; ƒ₁ is the grid coverage rate; ƒ₂ is the scalar field reconstruction error.

5. The data acquisition point deployment method according to claim 1, wherein the optimizing a location set of sampling points by a particle swarm optimization algorithm and a gravitational search algorithm, to determine the best solution of the location set of the sampling points and a fitness value corresponding to the best solution specifically comprises:
(1) initializing the location and velocity of each particle in a particle swarm, wherein the location satisfies the formula
$$X = ( \begin{matrix}{{X}^{V}}_{1} \\ {{X}^{V}}_{2} \\ M \\ {{X}^{V}}_{N}\end{matrix} ) = ( \begin{matrix}{X}_{11} & {X}_{12} & {X}_{13} & {X}_{1 D} \\ {X}_{21} & {X}_{22} & {X}_{23} & {X}_{2 D} \\ M & M & O & M \\ {X}_{N 1} & {X}_{N 2} & {X}_{N 3} & {X}_{ND}\end{matrix} ) ,$$
and the velocity satisfies the formula
$$V = ( \begin{matrix}{{V}^{V}}_{1} \\ {{V}^{V}}_{2} \\ M \\ {{V}^{V}}_{N}\end{matrix} ) = ( \begin{matrix}{V}_{11} & {V}_{12} & {V}_{13} & {V}_{1 D} \\ {V}_{21} & {V}_{22} & {V}_{23} & {V}_{2 D} \\ M & M & O & M \\ {V}_{N 1} & {V}_{N 2} & {V}_{N 3} & {V}_{ND}\end{matrix} ) ;$$
the particle represents a location set of a group of sampling points, i.e. [symbol] =(Xᵢ₁, Xᵢ₂, . . . , X_{iD}), wherein X_{id}=(x_{id}, y_{id}), i=1, 2, . . . , N and d=1, 2, . . . , D; X_{id} indicates the location of a sampling point d; \vec{X}ᵢ indicates the location of a particle i; V_{id} indicates the velocity of the sampling point d; \vec{V}ᵢ indicates the velocity of the particle i;
(2) determining a maximum iteration number Gₘₐₓ.
(3) calculating a fitness value fitness_{\vec{X}}_{ᵢ} of the particle according to the fitness function;
(4) comparing the fitness values of all particles in the particle swarm, determining a minimum value of the fitness values, using a particle corresponding to the minimum value of the fitness values as the best solution of the location set of the sampling points, and using the minimum value of the fitness values as a fitness value fitness [symbol] corresponding to the best solution; and
(5) determining whether an iteration number reaches the maximum iteration number; if yes, outputting the best solution of the location set of the sampling points and the fitness value fitness [symbol] corresponding to the best solution; if not, updating the velocity and location of each of the particles by the formulas [symbol] ^{T}=w× [symbol] ^{T}+ [symbol] ^{T}+c×randᵢ×( [symbol] ^{T}− [symbol] ^{T}) and [symbol] ^{T}= [symbol] ^{T}+ [symbol] ^{T}, and returning to the step (3), wherein \vec{V}ᵢ^{T} indicates transposition of a velocity matrix of the particle i; \vec{V}ᵢ₊₁^{T} indicates transposition of a velocity matrix of the particle i after updating; [symbol] ᵢ^{T} indicates transposition of a location matrix of the particle i; \vec{X}ᵢ₊₁^{T} indicates transposition of a location matrix of the particle i after updating; c indicates a learning factor; randᵢ indicates a uniform random number of [0,1]; Lbest is a global best solution in the optimization process; w is an inertia weight;
a calculation formula of the inertia weight is:
$$w = \{ \begin{matrix}{w}_{min} - \frac{( {w}_{max} - {w}_{min} ) \times ( f - {f}_{min} )}{( {f}_{avg} - {f}_{min} )} , f \leq {f}_{avg} \\ {w}_{max} , f > {f}_{avg}\end{matrix} ,$$
wherein wₘₐₓ is a maximum value of the inertia weight; wₘᵢₙ is a minimum value of the inertia weight; ƒ indicates a fitness function value of the particle; ƒ_{avg} indicates an average fitness function value of all particles; ƒₘᵢₙ indicates a minimum fitness function value of all particles.

6. A data acquisition point deployment system, wherein the system comprises:
a grid coverage rate and scalar field reconstruction error determining unit, for determining a grid coverage rate of a to-be-detected water area and a scalar field reconstruction error of an environment field of non-uniformly distributed water quality features;
a fitness function construction unit, for constructing a fitness function by combining the grid coverage rate and the scalar field reconstruction error;
an optimizing unit, for optimizing a location set of sampling points by a particle swarm optimization algorithm and a gravitational search algorithm according to the fitness function, to determine the best solution of the location set of the sampling points and a fitness value corresponding to the best solution; and
a deployment unit, for deploying a data sampling point in the to-be-detected water area according to the location of a sampling point corresponding to the best solution of the location set of the sampling points.

7. The data acquisition point deployment system according to claim 6, wherein the grid coverage rate and scalar field reconstruction error determining unit comprises a grid coverage rate determining subunit; the grid coverage rate determining subunit is configured for determining the grid coverage rate of the to-be-detected water area, and specifically comprises:
a grid partition module, for discretizing S zones in a two-dimensional plane of the to-be-monitored water area into grids of equal unit side length, the number of the grids being C;
a random deployment module, for randomly deploying D sampling points on the grids, the location of each of the sampling points being X_{d}=(x_{d}, y_{d}), d=1, 2, L, D;
a Boolean sensing model determining module, for using a Boolean sensing model to determine whether a grid in which a sampling point is located is covered, to obtain a determination result, the Boolean sensing model being:
$$P ( {X}_{d} , p ) = \{ \begin{matrix}1 & Dis ( {X}_{d} , p ) \leq {R}_{S} \\ 0 & Dis ( {X}_{d} , p ) > {R}_{S}\end{matrix} ,$$
wherein when Dis(X_{d}, p)≤R_{S}, P(X_{d}, p)=1, indicating that the grid where the sampling point is located is covered; when Dis(X_{d}, p)>R_{S}, P(X_{d}, p)=0, indicating that the grid where the sampling point is located is not covered; Dis(X_{d}, p) is an Euclidean distance from the sampling point d to a central point p=(x, y) of any of the grids: Dis(X_{d}, p)=\sqrt{(x_{d}−x)²+(y_{d}−y)²}; R_{S} is an effective sensing radius of a monitoring point;
a covered grid number determining module, for determining the number C_{S} of covered grids according to the determination result; and
a grid coverage rate calculation module, for calculating the grid coverage rate according to the formula
$${f}_{1} = \frac{{C}_{S}}{C} .$$

8. The data acquisition point deployment system according to claim 6, wherein the grid coverage rate and scalar field reconstruction error determining unit further comprises a scalar field reconstruction error determining subunit; the scalar field reconstruction error determining subunit is configured for determining the scalar field reconstruction error of the environment field of non-uniformly distributed water quality features, and specifically comprises:
an error analysis point determining module, for determining the number I of error analysis location points (x, y);
a temperature obtaining module, for obtaining a true temperature value Z of any of the location points in the environment field of non-uniformly distributed water quality features and an estimated value Z corresponding to the true temperature value Z of the location point; and
a scalar field reconstruction error calculation module, for calculating the scalar field reconstruction error by the formula
$${f}_{2} = \frac{1}{I} {\sum }_{i = 1}^{I} {( Z - {Z}^{′} )}^{2} .$$

9. The data acquisition point deployment system according to claim 6, wherein the fitness function construction unit is configured for constructing a fitness function, and specifically comprises:
a fitness function construction subunit, for constructing a fitness function with a purpose of maximizing the grid coverage rate and minimizing the scalar field reconstruction error, the fitness function being: fitness=a*(1−ƒ₁)+b*ƒ₂;
wherein a and b are constant factors; ƒ₁ is the grid coverage rate; ƒ₂ is the scalar field reconstruction error.

10. The data acquisition point deployment system according to claim 6, wherein the optimizing unit is configured for optimizing a location set of sampling points by a particle swarm optimization algorithm and a gravitational search algorithm, to determine the best solution of the location set of the sampling points and a fitness value corresponding to the best solution, and specifically comprises:
a particle initializing subunit, for initializing the location and velocity of each particle in a particle swarm, wherein the location satisfies the formula
$$X = ( \begin{matrix}{\vec{X}}_{1} \\ {\vec{X}}_{2} \\ ⋮ \\ {\vec{X}}_{N}\end{matrix} ) = ( \begin{matrix}{X}_{11} & {X}_{12} & {X}_{13} & {X}_{1 D} \\ {X}_{21} & {X}_{22} & {X}_{23} & {X}_{2 D} \\ ⋮ & ⋮ & ⋱ & ⋮ \\ {X}_{N 1} & {X}_{N 2} & {X}_{N 3} & {X}_{ND}\end{matrix} ) ,$$
and the velocity satisfies the formula
$$V = ( \begin{matrix}{\vec{V}}_{1} \\ {\vec{V}}_{2} \\ ⋮ \\ {\vec{V}}_{N}\end{matrix} ) = ( \begin{matrix}{V}_{11} & {V}_{12} & {V}_{13} & {V}_{1 D} \\ {V}_{21} & {V}_{22} & {V}_{23} & {V}_{2 D} \\ ⋮ & ⋮ & ⋱ & ⋮ \\ {V}_{N 1} & {V}_{N 2} & {V}_{N 3} & {V}_{ND}\end{matrix} ) ;$$
the particle represents a location set of a group of sampling points, i.e. [symbol] =(Xᵢ₁, Xᵢ₂, . . . , X_{iD}), where X_{id}=(x_{id}, y_{id}), i=1, 2, . . . , N and d=1, 2, . . . , D; X_{id} indicates the location of a sampling point d; \vec{X}ᵢ indicates the location of a particle i; V_{id} indicates the velocity of the sampling point d; \vec{V}ᵢ indicates the velocity of the particle i;
a maximum iteration number determining subunit, for determining a maximum iteration number Gₘₐₓ;
a fitness function calculation subunit, for calculating a fitness value fitness_{\vec{X}}_{ᵢ} of the particle according to the fitness function;
a fitness value comparison subunit, for comparing the fitness values of all particles in the particle swarm, determining a minimum value of the fitness values, using a particle corresponding to the minimum value of the fitness values as the best solution of the location set of the sampling points, and using the minimum value of the fitness values as a fitness value fitness [symbol] corresponding to the best solution; and
an iteration number determination subunit, for determining whether an iteration number reaches the maximum iteration number; if yes, outputting the best solution of the location set of the sampling points and the fitness value fitness [symbol] corresponding to the best solution; if not, updating the velocity and location of each of the particles by the formulas [symbol] ^{T}=w× [symbol] ^{T}+ [symbol] ^{T}+c×randᵢ×( [symbol] ^{T}− [symbol] ^{T}) and [symbol] ^{T}= [symbol] ^{T}+ [symbol] ^{T}, and returning to the fitness function calculation subunit;
wherein \vec{V}ᵢ^{T} indicates transposition of a velocity matrix of the particle i; \vec{V}ᵢ₊₁^{T} indicates transposition of a velocity matrix of the particle i after updating; [symbol] ᵢ^{T} indicates transposition of a location matrix of the particle i; \vec{X}ᵢ₊₁^{T} indicates transposition of a location matrix of the particle i after updating; c indicates a learning factor; randᵢ indicates a uniform random number of [0,1]; Lbest is a global best solution in the optimization process; w is an inertia weight;
a calculation formula of the inertia weight is:
$$w = \{ \begin{matrix}{w}_{min} - \frac{( {w}_{max} - {w}_{min} ) \times ( f - {f}_{min} )}{( {f}_{avg} - {f}_{min} )} , f \leq {f}_{avg} \\ {w}_{max} , f > {f}_{avg}\end{matrix} ,$$
wherein wₘₐₓ is a maximum value of the inertia weight; wₘᵢₙ is a minimum value of the inertia weight; ƒ indicates a fitness function value of the particle; ƒ_{avg} indicates an average fitness function value of all particles; ƒₘᵢₙ indicates a minimum fitness function value of all particles.
